(19) United States
(12) Patent Application Publication
(10) Pub. No.: US 2024/0063738 A1
(43) Pub. Date: Feb. 22, 2024

(54) MOTOR CONTROL DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Nobuyuki SUZUKI, Tokyo (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 18/448,249

(22) Filed: Aug. 11, 2023

(30) Foreign Application Priority Data
Aug. 17, 2022 (JP) 2022-130097

(51) Int. Cl. H02P 21/09; H02P 21/14; H02P 21/18; H02P 21/22

(52) U.S. Cl. CPC H02P 21/09; H02P 21/141; H02P 21/18; H02P 21/22

(57) ABSTRACT

Embodiments provide a motor control device including a current detection element connected to a DC side of the inverter circuit to generate a signal corresponding to a current value and configured to determine a rotor position based on at least a phase current of the motor and to generate a two-phase or three-phase PWM signal pattern to follow the rotor position. The PWM signal generation unit generates a phase-shifted PWM signal pattern with three phases such that the current detection unit is capable of detecting two-phase currents at two fixed time-points within a carrier wave cycle of the PWM signal. The motor control device is configured to estimate a rotating magnetic field angle and a speed of the motor based on the estimated magnetic flux interlinkage of an armature coil of the motor and to output a switching command so as to cause the PWM signal generation unit to generate different PWM signal according to a level of a modulation rate of a motor applied voltage. The motor control device is configured to use a speed estimated in a previous control cycle and to generate an angle computed based on the speed when the motor current is not detectable in one cycle of an electrical angle at a time of generating the two-phase or three-phase PWM signal pattern.

### FIELD OF THE INVENTION

Embodiments of the present invention relate to a control device that perform PWM control on a plurality of switching elements connected to each other in a three-phase bridge to control a motor via an inverter circuit, and particularly to sensorless control based on a one-shunt current detection method.

### DESCRIPTION OF THE RELATED ART

There is a technique of detecting a current using a single shunt resistor inserted into a DC section of an inverter circuit in a case of detecting U-phase, V-phase, and W-phase currents to control a motor. In order to detect all three phase currents with such a method, a three-phase PWM signal pattern needs to be generated such that two or more phase currents can be detected within one cycle of a pulse width modulation (PWM) carrier (a carrier wave).

For this reason, a technique is disclosed in Patent Literature 1 (Japanese Patent No. 5178799) that can always detect two or more phase currents without increasing noise even in a region where a modulation rate of a motor applied voltage is low by shifting a phase of a PWM signal within one cycle. On the other hand, as a method of estimating a motor speed and a motor angle from an estimated magnetic flux, a flux observer has been proposed in Non-Patent Literature 1 (Inoue and five others, “Experimental Verification of Flux Estimation Method Expanding Operation Region for Direct Torque Control in PMSM”, Papers for National Conference of the Institute of Electrical Engineers of Japan in 2021, Institute of Electrical Engineers of Japan, Mar. 1, 2021, 5-095). In the flux observer method, an α-axis component ψα and a β-axis component ψβ of a magnetic flux interlinkage of a motor coil are estimated based on, for example, tow-phase currents Iα and Iβ obtained from a current sensor, two-phase voltages Vα and Vβ, and a motor coil resistor R, and a rotating magnetic field angle of the motor, and a phase angle and a generated torque T of a rotor are estimated.

In the flux observer disclosed in Non-Patent Literature 1, it is assumed that a current sensor such as a CT or a three-shunt current detection method is applied for the current used to estimate the magnetic flux. However, a one-shunt current detection method is often applied in order to reduce costs of inverters or the like in home appliances. When the one-shunt current detection method is applied, there is a possibility in a case where a modulation rate of a motor applied voltage is low at a low speed from a startup that the current cannot be detected and an error will occur in the estimation of the magnetic flux. Particularly, when a previous value is used during non-detection of the current in a case where an α-axis current and a β-axis current, which change in a sine wave, are used for computation of magnetic estimation, there is a problem that an error in estimation of the magnetic flux interlinkage increases.

### BRIEF DESCRIPTION OF THE DRAWINGS

FIG. 1 is a functional block diagram showing a configuration of a motor control device according to a first embodiment;

FIG. 2 is a diagram showing a vector control block using a flux observer;

FIG. 3 is a functional block diagram showing a detail configuration of a position estimation control unit;

FIG. 4 is a functional block diagram showing a configuration of an integrator used in a magnetic flux estimation unit;

FIG. 5 is a flowchart showing angle compensation processing in a one-shunt current detection method;

FIG. 6 is a diagram showing an example of a current detection rate according to a PWM output method;

FIG. 7 is a functional block diagram showing a configuration of a motor control device according to a second embodiment;

FIG. 8 is a functional block diagram showing a configuration of an integrator used in a magnetic flux estimation unit according to a third embodiment;

FIG. 9 is a diagram showing a relationship between an actual angle and an estimated angle in a low speed region according to the first embodiment;

FIG. 10 is a diagram showing a relationship between an actual angle and an estimated angle in a low speed region according to the third embodiment;

FIG. 11 is a flowchart showing processing at the start of a motor according to a fourth embodiment;

FIG. 12 is a diagram showing signal waveforms;

FIG. 13 is an enlarged view of a portion in FIG. 12;

FIG. 14 is a functional block diagram showing a configuration of a motor control device according to a fifth embodiment; and

FIG. 15 is a flowchart showing processing for switching a carrier wave frequency and an output pattern of a PWM signal according to a level of a modulation rate.

### DETAILED DESCRIPTION OF THE EMBODIMENTS

Therefore, embodiments of the present invention provide a motor control device that prevents an error in estimation of a magnetic flux interlinkage that can occur in a low-speed region from a startup and enables a stable motor drive when a flux observer method of estimating a phase angle and a speed of a rotating magnetic field of a motor from an estimated magnetic flux interlinkage and a one-shunt current detection method are combined.

Embodiments provides a motor control device configured to perform on/off control on a plurality of switching elements connected to each other in a three-phase bridge according to a predetermined PWM signal pattern and to drive a motor via an inverter circuit that converts a direct current (DC) into a three-phase alternating current (AC), the motor control device including:
a current detection element connected to a DC side of the inverter circuit to generate a signal corresponding to a current value;
a PWM signal generation unit configured to determine a rotor position based on at least a phase current of the motor and to generate a two-phase or three-phase PWM signal pattern to follow the rotor position; and
a current detection unit configured to detect the phase current of the motor based on the signal generated by the current detection element and the PWM signal pattern,
the PWM signal generation unit being configured to generate a PWM signal pattern with three phases such that the current detection unit is capable of detecting two-phase currents at two fixed time-points within a carrier wave cycle of the PWM signal,
the motor control device further including: a signal switching output unit configured to estimate a rotating magnetic field angle and a speed of the motor based on the magnetic flux interlinkage, and to output a switching command so as to cause the PWM signal generation unit to generate different PWM signal patterns according to a level of a modulation rate of a motor applied voltage; and
an angle compensation unit configured to use a speed estimated in a previous control cycle and to generate an angle computed based on the speed estimated in the previous control cycle when the motor current is not detectable in one cycle of an electrical angle at a time of generating the two-phase or three-phase PWM signal pattern.

### First Embodiment

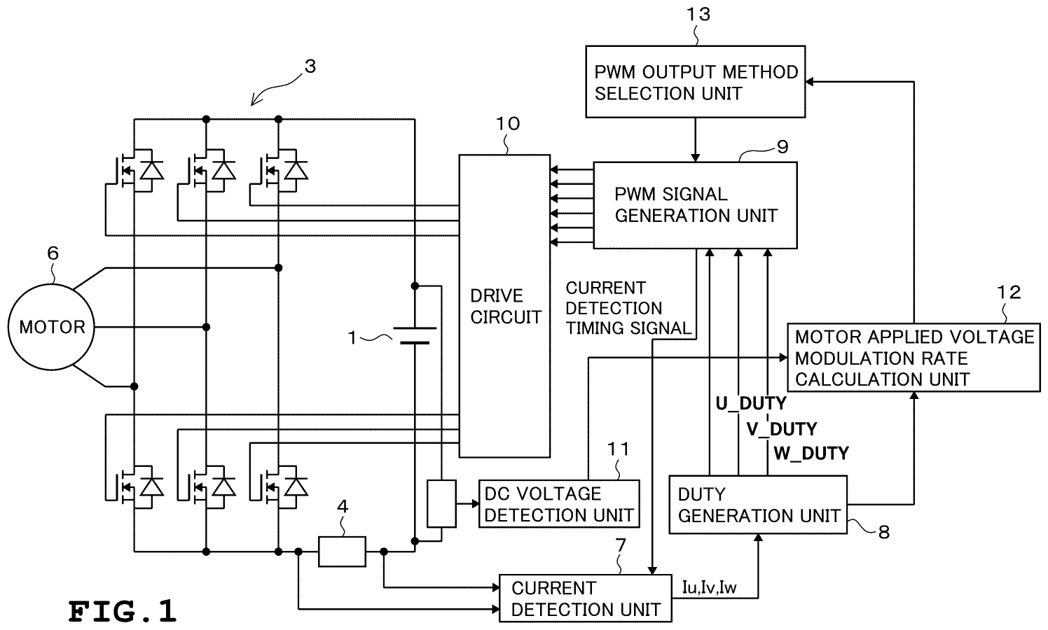

FIG. 1 is a functional block diagram showing a configuration of a motor control device of the present embodiment, which is obtained by adding some functional blocks to FIG. 1 of Patent Literature 1. A DC power source unit 1 is indicated by a symbol of a DC power source, but includes a rectifier circuit, a smoothing capacitor, and the like when a DC power source is generated from a commercial AC power source. An inverter circuit 3 is connected to the DC power source unit 1 via a positive-side bus line 2a and a negative-side bus line 2b, but a shunt resistor 4 as a current detection element is inserted toward the negative-side bus line. The inverter circuit 3 includes switching elements, which are, for example, N-channel type power MOSFETs 5 (U+, V+, W+, U−, V−, and W−) connected to each other in a three-phase bridge, and an output terminal of each phases is connected to each of phase coils of a motor 6, which is, for example, a brushless DC motor.

A terminal voltage of the shunt resistor 4 is detected by a current detection unit 7. The current detection unit 7 detects currents Iu, Iv, and Iw of phases U, V, and W, respectively, based on the terminal voltage and three-phase PWM signal patterns output to the inverter circuit 3. When each of the phase currents detected by the current detection unit 7 is given to a DUTY generation unit 8 and is subjected to A/D conversion to be read, a computation is performed based on control conditions of the motor 6. As a result, duties U_DUTY, V_DUTY, and W_DUTY for generating PWM signals of the phases, respectively, are determined.

For example, in a case of performing vector control, when a rotation speed command ωref of the motor 6 is given to the DUTY generation unit 8 from a microcomputer or the like that sets the control conditions, a torque current command Iqref is generated based on a difference from an estimated actual rotation speed of the motor 6. When a rotor position θ of the motor 6 is determined from the phase currents Iu, Iv, and Iw of motor 6, a torque current Iq and an excitation current Id are calculated by a vector control computation using the rotor position θ. For example, a PI control computation is performed on the difference between the torque current command Iqref and the torque current Iq to generate a voltage command Vq. The same process is performed on the excitation current Id to generate a voltage command Vd, and the voltage commands Vq and Vd are converted into three-phase voltages Vu, Vv, and Vw using the rotor position θ. Then, phase duties U_DUTY, V_DUTY, and W_DUTY are determined based on these three-phase voltages Vu, Vv, and Vw, respectively.

Each of the phase duties U_DUTY, V_DUTY, and W_DUTY is given to a PWM signal generation unit 9, and a three-phase PWM signal is generated by comparing a level with a carrier wave. Further, signals on a lower arm side are also generated by inverting the three-phase PWM signals, and the signals are output to the drive circuit 10 after dead time is added as necessary. The drive circuit 10 outputs a gate signal to each of gates of six power MOSFET 5 (U+, V+, W+, U−, V−, and W−) constituting the inverter circuit 3 according to the given PWM signal. For an upper arm side, a potential boosted by a necessary level is output.

A DC voltage detection unit 11 detects a voltage of the DC power source 1, and outputs a detection result to a motor applied voltage modulation rate calculation unit 12. The motor applied voltage modulation rate calculation unit 12 calculate a modulation rate of the voltage applied to the motor 6 via the inverter circuit 3, based on duty information input or the like from the DUTY generation unit 8. The calculated modulation rate is output to a PWM output method selection unit 13. The PWM output method selection unit 13 serving as a signal switching output unit outputs a switching signal for switching an output method of the PWM signal by the PWM signal generation unit 9 according to the modulation rate to be input.

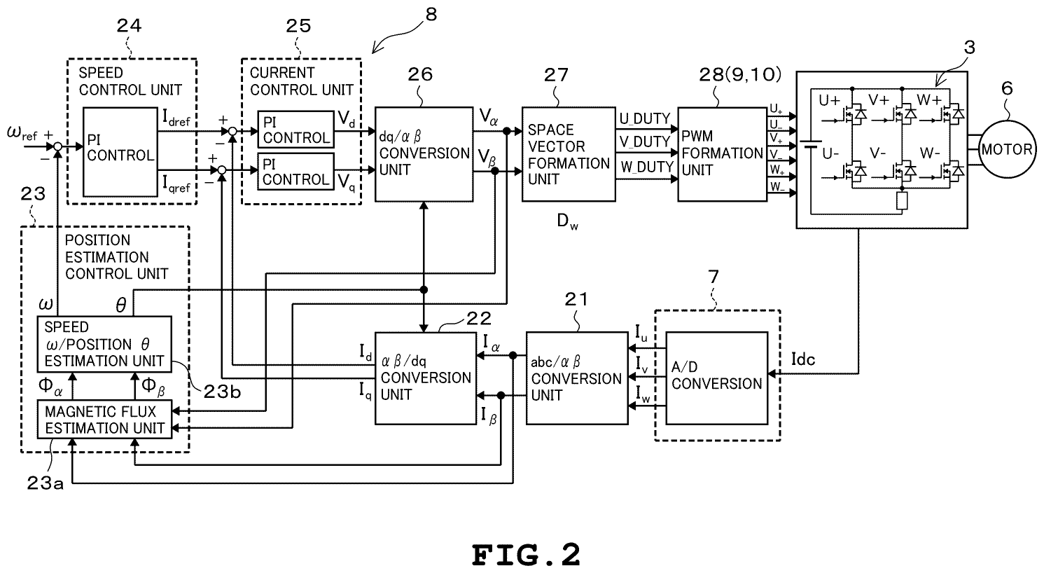

FIG. 2 shows a vector control block using a flux observer. In FIG. 2, each of the phase currents detected by the current detection unit 7 is converted into an a-axis component Iα and a β-axis component Iβ of a current of the motor by an abc/αβ conversion unit 21 of the DUTY generation unit 8. The currents Iα and Iβ obtained by such a conversion are given to a position estimation control unit 23. The position estimation control unit 23 estimates a magnetic flux based on the currents Iα and Iβ and voltage commands Vα and Vβ input from a dq/αβ conversion unit 26, which will be described below.

The position estimation control unit 23 includes a magnetic flux estimation unit 23a and a speed/position estimation unit 23b. The magnetic flux estimation unit 23a estimates an α-axis component φα and a β-axis component σβ of a magnetic flux interlinkage according to Formulas (1) and (2) below. Here, L uses mutual inductance. The mutual inductance may be substituted by Self-inductance, d-axis inductance Ld, and q-axis inductance Lq.

φα=∫(Vα−R×Iα)dt−LIα (1)

φβ=∫(Vβ−R×Iβ)dt−LIβ (2)

Based on the estimated magnetic fluxes φα and φβ, the speed/position estimation unit 23b first estimates a phase θ and a torque T of a rotating magnetic field using an a-axis as a basis, according to Formulas (3) and (4) below.

θ=ATAN(φβ/φα) (3)

T=3/2×(number of pole pairs)×(φα×Iβ−φβ×Iα) (4)

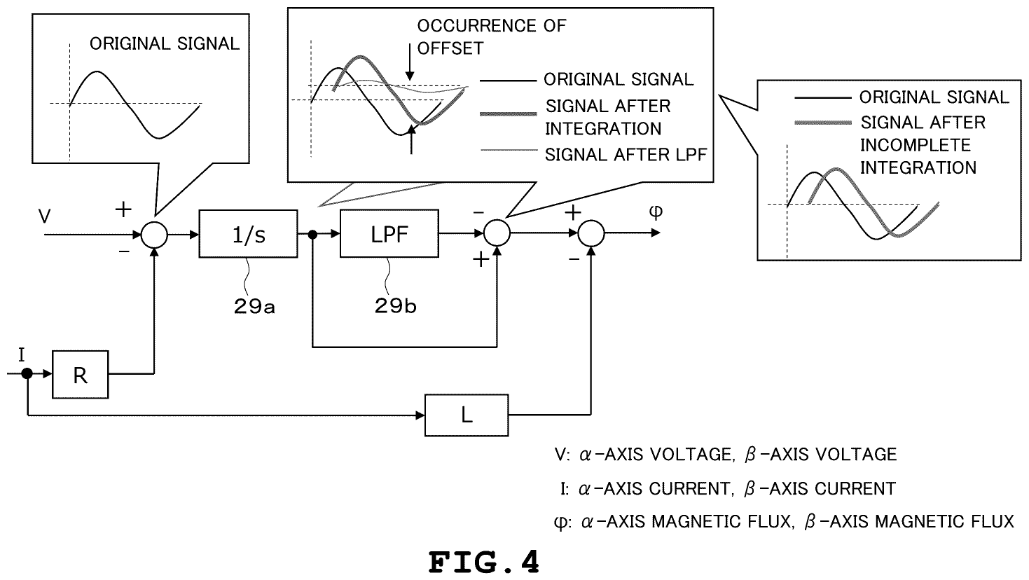

An integrator on a right side of each of Formulas (1) and (2) integrates the magnetic flux as shown in FIG. 4, using an incomplete integration method by an LPF (Low Pass Filter) with a cutoff angular frequency ωc as shown in a transfer function of Formula (5). Here, a symbol “s” indicates a differential operator.

G(S)=1/(s+ωc) (5)

When a frequency of the magnetic flux is sufficiently larger than the cutoff angular frequency ωc, it is possible to obtain an excellent estimation result. A speed ω is estimated by differentiation of the phase θ estimated by Formula (3). As the LPF, not only a general LPF but also an IIR (Infinite Impulse Response) filter, a FIR (Finite Impulse Response) filter, or the like may be applied.

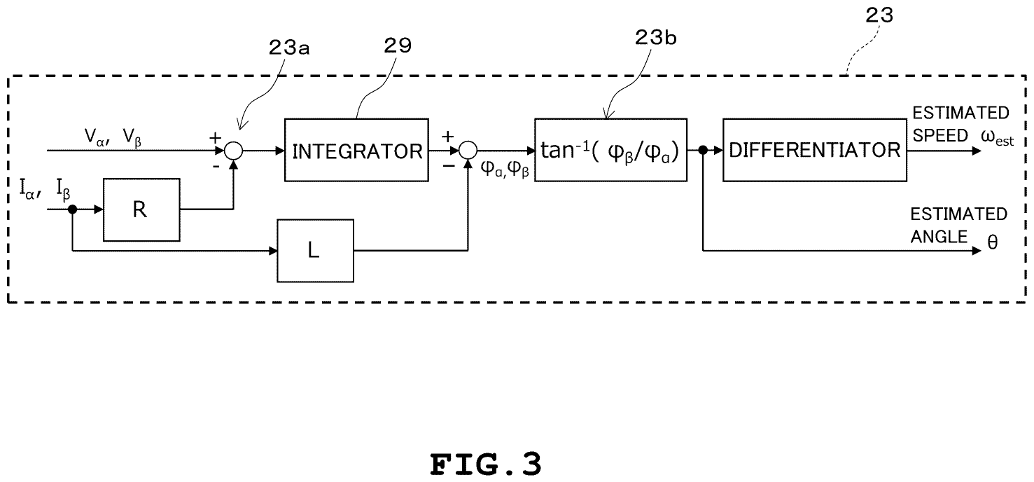

FIG. 3 is a functional block diagram showing in more detail an internal configuration of the position estimation control unit 23 corresponding to the above-described computation. An integrator 29 of the magnetic flux estimation unit 23a shown in FIG. 3 is actually configured by a combination of an integrator 29a and a lowpass filter (LPF) 29b as shown in FIG. 4, and employs a so-called incomplete integration method. An output signal of the integrator 29a contains an offset. The offset component is extracted by filtering of the output signal with the LPF 29b, and the offset component is canceled by subtraction of the offset component with a subtractor in a subsequent stage. The LPF 29b and the subtractor in the subsequent stage may be configured by an HPF (High Pass Filter). Information on a rotator speed of the motor 6 is required for speed control. When the flux observer is used in the configuration of vector control, the fact is used that the rotating magnetic speed of the motor 6 and the rotor speed constantly match.

FIG. 2 is referred to again. The rotation speed command ωref of the motor 6 is given by a host control device such as a microcomputer for setting control conditions. A speed control unit 24 generates the torque current command Iqref based on the difference between the rotation speed command ωref and the rotation speed ω estimated by the position estimation unit 23. The αβ/dq conversion unit 22 calculates the torque current Iq and the excitation current Id from the currents Iα and Iβ by the vector control computation using the rotor position θ.

In a current control unit 25, for example, a PI control computation is performed on the difference between the torque current command Iqref and the torque current Iq to generate the voltage command Vq. The same process is performed on the excitation current Id to generate the voltage command Vd. A space vector generation unit 27 converts the voltage commands Vq and Vd into three-phase voltages Vu, Vv, and Vw using the rotor position θ. Then, phase duties U_DUTY, V_DUTY, and W_DUTY for generating PWM signals of the phases are determined based on the three-phase voltages Vu, Vv, and Vw, respectively.

Each of the phase duties U_DUTY, V_DUTY, and W_DUTY is given to a PWM formation unit 28, and a two-phase or three-phase PWM signal is generated by comparing a level with a carrier wave. In addition, signals on a lower arm side are also generated by inverting the two-phase or three-phase PWM signals, and the signals are output to the drive circuit 10 after dead time is added as necessary. As for the method of generating the three-phase PWM signals with phases shifted by the PWM formation unit 28, a method of a fourth embodiment disclosed in Patent Literature 1 is used, for example.

The motor applied voltage modulation rate calculation unit 12 shown in FIG. 1 calculates a modulation rate of a motor applied voltage for each carrier cycle as indicated by Formula (6), based on Vα and Vβ calculated by the DUTY generation unit 8.

(Modulation rate)=100×Vdc/(√3×√(Vq²+Vd²)) (6)

The calculation result is output to the PWM output method selection unit 13. The PWM output method selection unit 13 outputs a signal for switching the PWM output signal to the PWM signal generation unit 9 based on such information. Further, a current detection timing signal is output from the PWM signal generation unit 9 to the current detection unit 7. The modulation rate of the motor applied voltage may be simply substituted by the motor rotation speed or the like.

Since the currents Iα and Iβ change in a sine wave in time series, when the magnetic flux is estimated using the currents Iα and Iβ estimated in the previous control cycle in a case where the phase current of the motor 6 cannot be detected in one-shunt current detection method, estimation accuracy may deteriorate. In addition, since the angle changes in a sawtooth wave, when the angle estimated in the previous control cycle is used in a case where the phase current of the motor 6 cannot be detected, an error occurs in the computation of the vector control system.

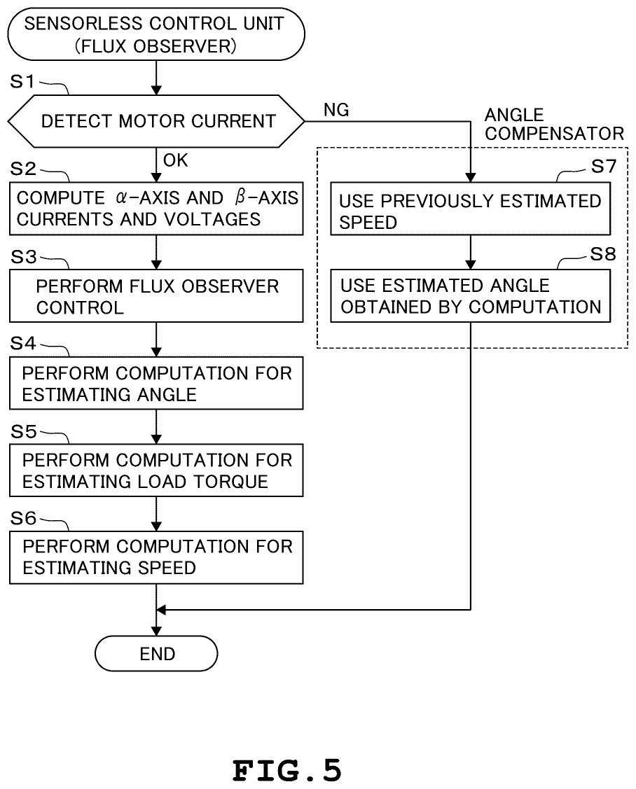

FIG. 5 shows a flowchart of angle compensation processing in a one-shunt current detection method using a flux observer. When the phase current can be detected (S1; OK), normal control is performed, α-axis and β-axis currents and voltages are computed (S2), and flux observer control is performed (S3). Then, computations for estimating the angle θ, the load torque T, and the speed ω are sequentially performed (S4 to S6). On the other hand, when the phase current cannot be detected (S1; NG), the speed ω estimated in the previous control cycle is used (S7), and the angle θ obtained by integration of the speed ω is used (S8). The processing is performed in the magnetic flux estimation unit 23a which is also an angle compensation unit.

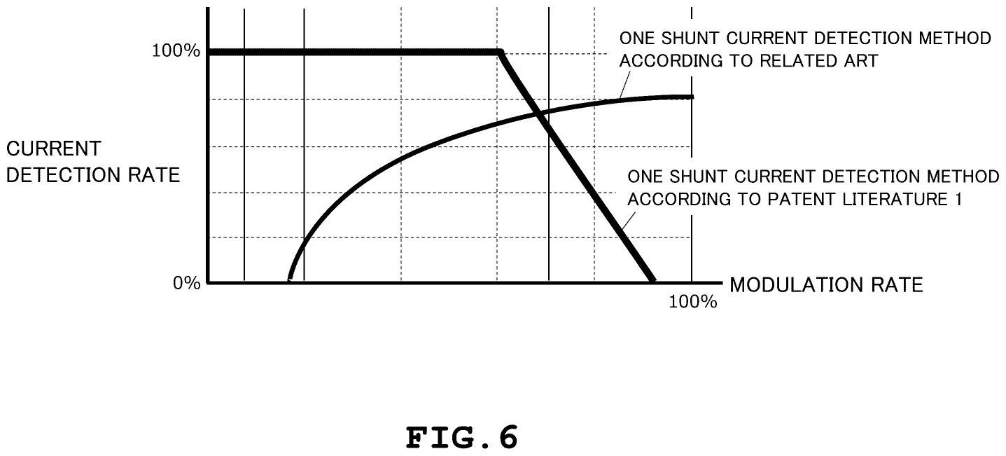

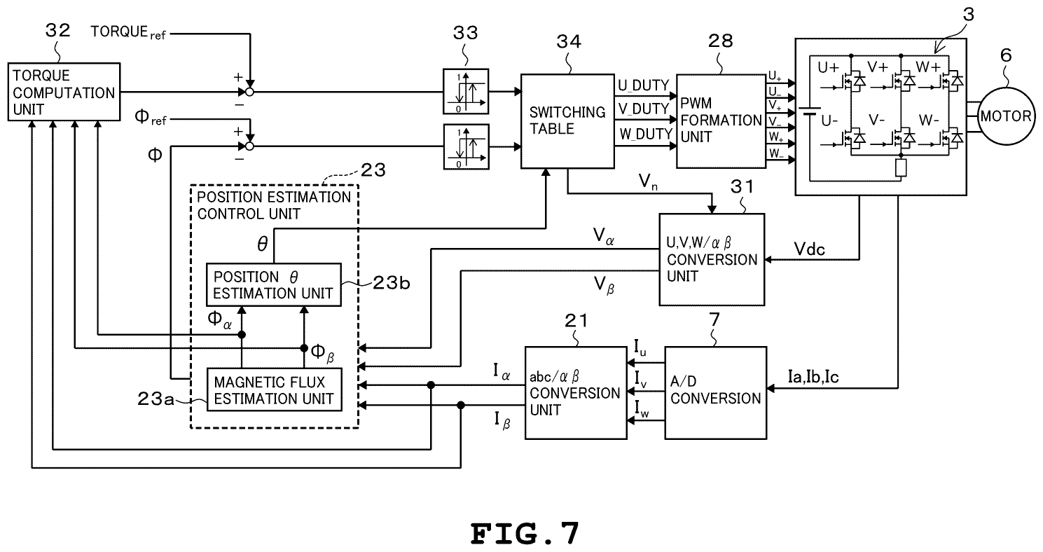

FIG. 6 shows an example of a current detection rate for each PWM output method. As the rotation speed of the motor and the load torque increase, the modulation rate of the motor applied voltage approaches 100%. When the modulation rate is in a low region, the PWM output method selection unit 13 generates a three-phase PWM signal pattern in which an output phase of a PWM signal pulse of each of phases is shifted by the method according to Patent Literature 1, which is different from the method according to the related art. On the other hand, when the modulation rate is in a high region, for example, as shown in FIG. 7 of Patent Literature 1, a switching command is output so as to generate a PWM signal pattern of pulse signals symmetrical with respect to the midpoint of the PWM cycle in two phases or three phases.

As described above, according to the present embodiment, the PWM signal generation unit 9 determines the rotor position based on at least the phase currents of the motor 6, and generates the two-phase or three-phase PWM signal pattern to follow the rotor position. The current detection unit 7 detects the phase currents of the motor 6 based on the signal generated in the shunt resistor 4 and the PWM signal pattern. The PWM signal generation unit 9 generates the phase-shifted PWM signal pattern with three phases such that the current detection unit 7 can detect two-phase currents at two fixed time-points within the carrier wave cycle of the PWM signal. At this time, one of the three phases increases or decreases the duty in both lagging and leading sides with reference to an arbitrary phase of the carrier wave cycle, another increases or decreases the duty in one direction on the lagging and leading sides, and the third increases or decreases the duty in a direction opposite to the above direction.

The magnetic flux estimation unit 23a estimates the magnetic flux interlinkage of the armature coil of the motor 6 based on the phase currents and the voltage commands of the motor 6, and estimates the rotating magnetic field angle and speed of the motor 6 based on the magnetic flux interlinkage. The PWM output method selection unit 13 outputs the switching command so as to cause the PWM signal generation unit 9 to generate the symmetrical PWM signal pattern in two phases or three phases when the modulation rate of the motor applied voltage is in the high region, and to generate the phase-shifted PWM signal pattern when the modulation rate is in the low region. When the motor current cannot be detected, the magnetic flux estimation unit 23a uses the previously estimated speed, and generates an angle computed based on the previous speed.

Here, the condition under which the motor current cannot be detected is that when a two-phase or three-phase PWM signal pattern is generated, a duration of the PWM signal for which the current is to be detected in one cycle of an electrical angle is shorter than a current detectable time, for example, 5-10 μsec in consideration of a current ripple and A/D conversion time or the like, for example. Therefore, even when “a phase-shifted PWM signal pattern with three phases is generated such that two-phase currents can be detected at two fixed time-points”, the detection rate is not always 100%, and the actual detection rate is generally in a range of 70% to 100%.

With such a configuration, even when the one-shunt current detection method is applied, the three-phase currents Iu, Iv, and Iw can be detected from a state in which the modulation rate of the motor applied voltage is low to a state in which the modulation rate is high, and the magnetic flux can be estimated based on the α-axis current and the β-axis current and the voltage command vector. Additionally, even when the phase current of the motor 6 cannot be detected, deterioration of position estimation accuracy can be prevented by using the previously estimated speed value.

### Second Embodiment

Hereinafter, the same components as those in the first embodiment are denoted by the same reference numerals and will not be described, and other components will be described. The first embodiment has described the case where the angle θ and the speed ω of the motor 6 are estimated based on the estimated magnetic flux and applied to the vector control. A second embodiment shows a case where flux observer control is applied to direct torque control.

As shown in FIG. 7, the direct torque control using the flux observer uses an UVW/αβ conversion unit 31, a torque computation unit 32 which is a direct torque control execution unit, a binary level output unit 33, and a switching table 34 instead of the αβ/dq conversion unit 22, the speed estimation unit 24, the current control unit 25, the dq/αβ conversion unit 26, and the space vector formation unit 27. Instead of the rotation speed command ωref, a target torque command Tref and a target flux command φref are input from the host control device. Then, a three-phase PWM signal pattern is generated with reference to the switching table 34. Since the direct torque control is a well-known technology, detailed descriptions thereof will not be given. As the motor, a synchronous reluctance motor or an induction motor can be applied in addition to a permanent magnet motor.

### Third Embodiment

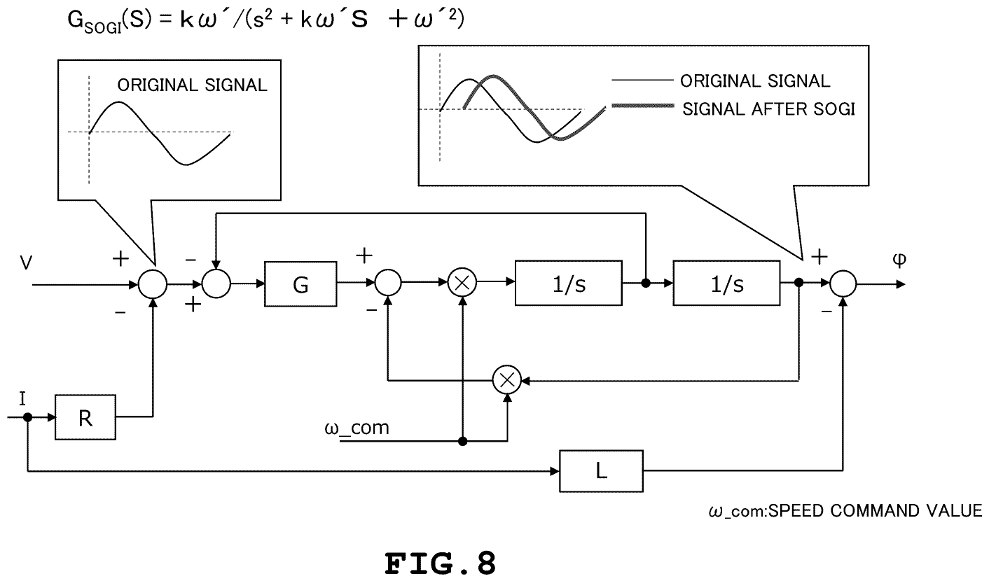

In the first embodiment, the incomplete integration method is adopted for the integrators on the right sides of Formulas (1) and (2). In the second embodiment, a second-order generalized integration method of a transfer function as shown in FIG. 8 and Formula (7) is used for the integration of magnetic flux in the same case.

G(S)=kω′/(s²+Kω′S+ω′²) (7)

Where, ω′ indicates a natural angular frequency of a second-order filter, and k indicates a coefficient used to determine attenuation.

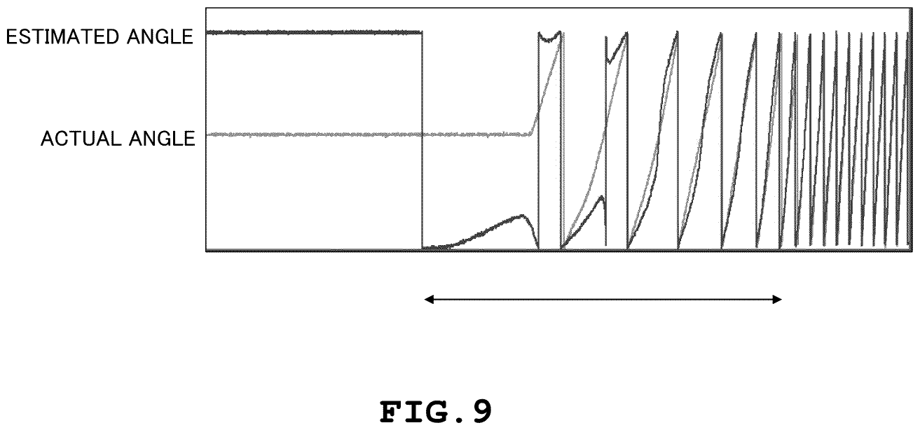

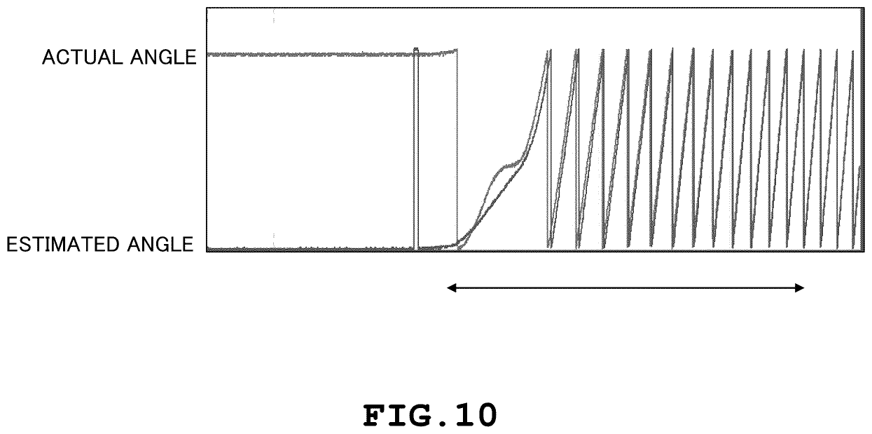

In the estimation of the magnetic flux by the incomplete integration method, the magnetic flux can be excellently estimated when the magnetic flux frequency is sufficiently larger than ωc, but since the LPF 29b is used, estimation accuracy deteriorates in a low-speed region indicated by a double-headed arrow in FIG. 9. In contrast, the second-order generalized integration method shown in FIG. 10 improves frequency characteristics in the low-speed region, so that the operable range can be expanded.

As described above, according to the third embodiment, when the output phase of the PWM signal pulse of each phase is shifted by the method of Patent Literature 1 to generate a three-phase PWM signal pattern and perform sensorless operation in a case where the modulation rate of the motor applied voltage is in a low region, since estimation accuracy in magnetic flux of the motor can be maintained even at low speed by integrating the magnetic flux using the second-order generalized integration method, sensorless control can be performed.

### Fourth Embodiment

According to the third embodiment, the estimation accuracy in magnetic flux of the motor can be maintained even at low speed. However, when the motor 6 starts, the magnetic flux of the motor cannot be estimated with sufficient accuracy. For this reason, it is conceivable to perform forced commutation in which a d-axis current is applied at an angle corresponding to the command speed at the startup and to switch to sensorless operation after increasing the rotation speed of the motor 6. However, when the load torque of the motor 6 is excessively large, there is a risk of stepping out. When a sufficiently large d-axis current is applied during the forced commutation, it is possible to cope with the load at the startup, but the power at the startup will increase.

Therefore, according to the fourth embodiment, at the start of the motor 6, a forced commutation is performed in which a d-axis current is applied according to the estimated angle of the magnetic flux of the motor. In addition, based on the difference between the command rotation speed and the estimated rotation speed of the motor 6, a torque current command Iqref is also applied. As a result, during the forced commutation at the startup, the d-axis current is applied when the motor load is small, and a q-axis current is applied when the motor load becomes large. Thus, even in the forced commutation at the startup, the motor current can be changed according to the load, and the motor 6 can be started without spending wasteful power.

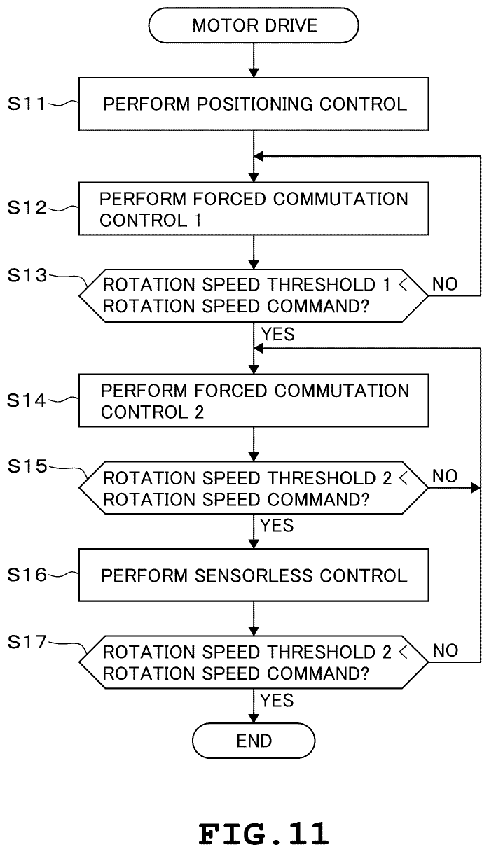

In a control sequence at the startup shown in FIG. 11, first, positioning control is performed (S11). Here, an excitation current command Idref is defined as a predetermined value set in advance, the torque current command Iqref is defined as zero, and the angle is defined as a target angle. Subsequently, “forced commutation control 1 is performed (S12). The current commands Idref and Iqref and the angle are the same as in step S11. Then, the rotation speed command ωref is increased, and when it is determined in step S13 that the rotation speed command ωref exceeds rotation speed threshold 1, the process proceeds to “forced commutation control 2” (S14).

In the “forced commutation control 2”, the excitation current command Idref is assumed to be, for example, approximately half the predetermined value in the “forced commutation control 1”. The torque current command Iqref uses the result of speed control in the vector control, and the angle is assumed to be a value estimated by the flux observer. Subsequently, when it is determined in step S15 that the rotation speed command ωref exceeds rotation speed threshold 2, the process proceeds to sensorless control (S16). Here, the excitation current command Idref is assumed to be zero. Then, the same determination is made as in step S15 (S17). When the rotation speed command ωref exceeds rotation speed threshold 2, the startup processing is completed, and when the rotation speed command is equal to or lower than rotation speed threshold 2, the process returns to step S14.

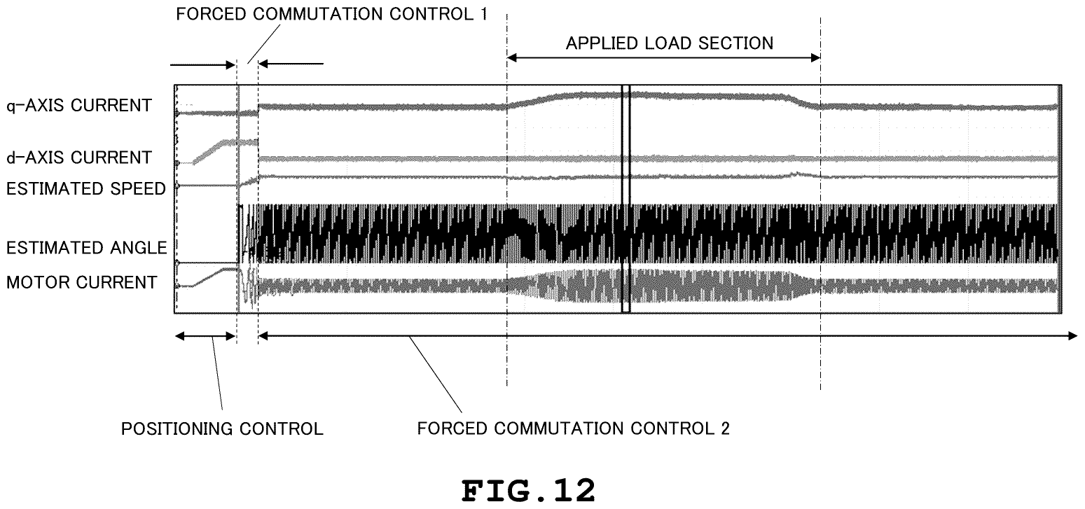

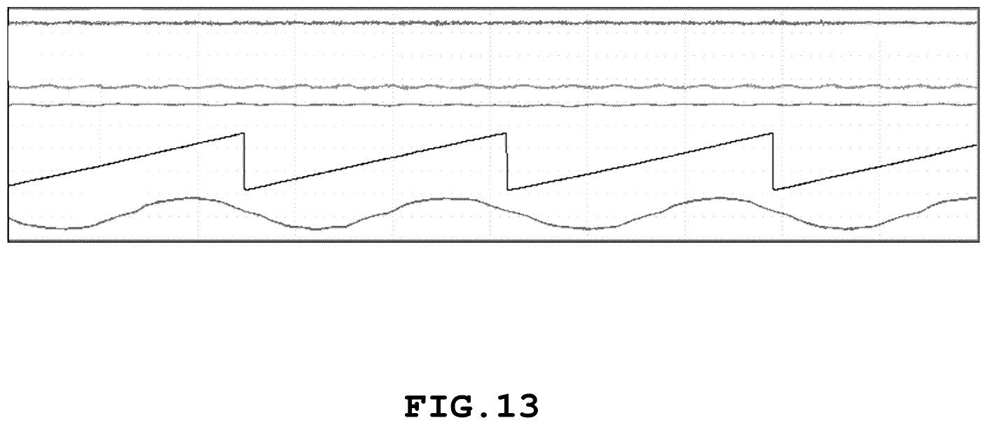

FIG. 12 shows operation waveforms of the motor when the forced commutation is performed according to the estimated angle of the magnetic flux of the motor, and FIG. 13 is an enlarged view of a portion enclosed by a rectangle in an applied load section in FIG. 12. The torque current component Iq increases even when the load increases during the forced commutation. Therefore, it can be seen that the motor output torque can be varied according to the load torque even during the forced commutation.

As described above, according to the fourth embodiment, at the start of the motor 6, the forced commutation is performed in which the d-axis current is applied according to the estimated angle of the magnetic flux of the motor, and based on the difference between the command rotation speed and the estimated rotation speed of the motor 6, and the torque current command Iqref is also applied, whereby the output torque of the motor 6 can be varied according to the load torque even during the forced commutation. Thus, the motor 6 can be started without spending wasteful power.

### Fifth Embodiment

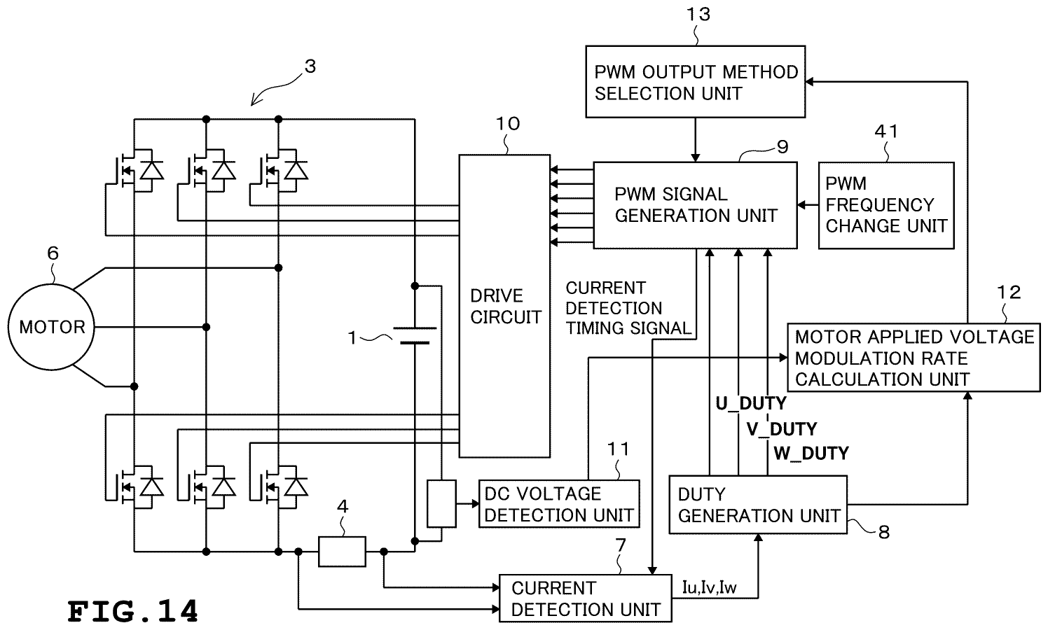

When the output phase of the PWM signal pulse of each phase is shifted as in the above-described embodiments, noise may become a problem when the frequency of the carrier wave is within an audible range to human, for example, 4 kHz. On the other hand, when the frequency of the carrier wave is increased over the entire range of the motor drive, there is a concern that switching loss of the inverter circuit 3 will increase and the overall efficiency will decrease. In a fifth embodiment, therefore, a PWM frequency change unit 41 shown in FIG. 14 changes the frequency of the PWM carrier wave according to the modulation rate region. Further, a PWM output method selection unit 13 changes the output pattern of the PWM signal in synchronization with the change of the frequency.

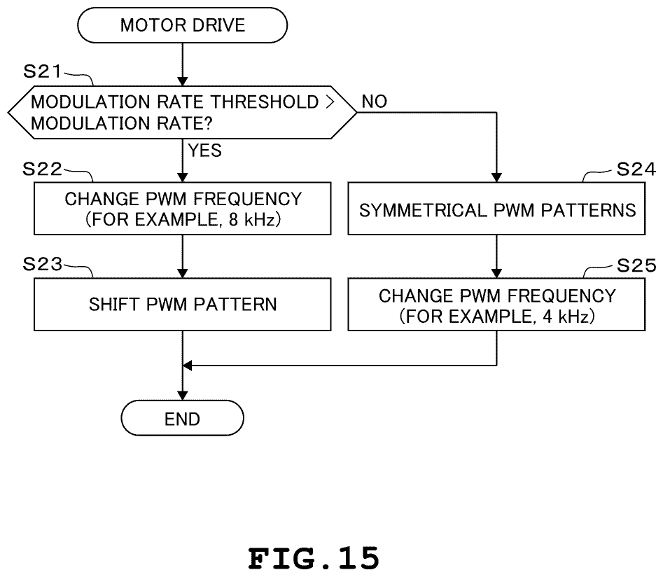

As shown in FIG. 15, when the modulation rate is less than a threshold (S21; YES), the frequency of the carrier wave is set to, for example, 8 k to 16 kHz or higher (S22), and a phase-shifted PWM signal is output (S23). On the other hand, when the modulation rate is equal to or greater than the threshold (S21; NO), a symmetrical PWM signal pattern is generated in two phases or three phases (S24), and the frequency of the carrier wave is set to as low as possible, for example, 4 kHz (S25). With such an output pattern, noise due to the frequency of the carrier wave is smaller compared with a case where the output phase is shifted. Either the output pattern of the PWM signal or the change in frequency of the carrier wave may be performed ahead. Further, the change in frequency of the carrier wave may be performed step by step or at once. In addition, the modulation rate of the motor applied voltage may be simply substituted by the motor rotation speed.

### OTHER EMBODIMENTS

First to third embodiments of Patent Literature 1 may be applied to a method of determining the arrangement of phase duty pulses.

Magnetic fluxes (pa and q 3 may be estimated by computation according to Formulas (8) and (9).

φα=∫(Vα−R×Iα)dt (8)

φβ=∫(Vβ−R×Iβ)dt (9)

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1: A motor control device configured to perform on/off control on a plurality of switching elements connected to each other in a three-phase bridge according to a predetermined PWM signal pattern and to drive a motor via an inverter circuit that converts a direct current (DC) into a three-phase alternating current (AC), the motor control device comprising:
a current detection element connected to a DC side of the inverter circuit to generate a signal corresponding to a current value;
a PWM signal generation unit configured to determine a rotor position based on at least a phase current of the motor and to generate a two-phase or three-phase PWM signal pattern to follow the rotor position;
a current detection unit configured to detect the phase current of the motor based on the signal generated by the current detection element and the PWM signal pattern;
the PWM signal generation unit being configured to generate a phase-shifted PWM signal pattern with three phases such that the current detection unit is capable of detecting two-phase currents at two fixed time-points in a carrier wave cycle of the PWM signal,
a magnetic flux estimation unit configured to estimate a magnetic flux interlinkage of an armature coil of the motor based on the phase current of the motor and an output voltage command;
a signal switching output unit configured to estimate a rotating magnetic field angle and a speed of the motor based on the magnetic flux interlinkage, and to output a switching command so as to cause the PWM signal generation unit to generate different PWM signal patterns according to a level of a modulation rate of a motor applied voltage; and
an angle compensation unit configured to use a speed estimated in a previous control cycle and to generate an angle computed based on the speed estimated in the previous control cycle when the motor current is not detectable in one cycle of an electrical angle at a time of generating the two-phase or three-phase PWM signal pattern.

2: The motor control device according to claim 1, wherein
the PWM signal generation unit generates the phase-shifted PWM signal pattern in a manner that one phase of a PWM signal with three phases increases or decreases a duty in both lagging and leading sides with reference to an arbitrary phase of the carrier wave cycle, another phase increases or decreases the duty in one direction on the lagging and leading sides with reference to the arbitrary phase of the carrier wave cycle, and the third phase increases or decreases the duty in a direction opposite to the direction with reference to the arbitrary phase of the carrier wave cycle.

3: The motor control device according to claim 1, wherein
the signal switching output unit outputs the switching command so as to cause the PWM signal generation unit to generate symmetrical PWM signal patterns in two phases or three phases when the modulation rate of the motor applied voltage is in a high region and to generate the phase-shifted PWM signal pattern when the modulation rate is in a low region.

4: The motor control device according to claim 1, wherein
the magnetic flux estimation unit estimates the magnetic flux interlinkage performing time integration based on the motor current and the output voltage command on αβ coordinates.

5: The motor control device according to claim 4, wherein
the magnetic flux estimation unit estimates the magnetic flux interlinkage by performing time integration on a value computed from the output voltage command on the αβ coordinates, the phase current of the motor, and a coil resistance value of the motor with a double integrator.

6: The motor control device according to claim 1, wherein
the signal switching output unit changes a frequency of a PWM carrier wave according to a modulation rate region.

7: The motor control device according to claim 1, further comprising
a forced commutation execution unit configured to perform forced commutation in which a d-axis current is applied using an estimated motor angle when the motor starts, the d-axis current being a field current component.

8: The motor control device according to claim 7, wherein
the forced commutation execution unit also applies a q-axis current, which is a torque current component, using a result of speed control when the forced commutation is performed.

9: The motor control device according to claim 1, further comprising
a vector control execution unit configured to perform vector control for controlling the motor using a motor angle and a motor speed computed from the magnetic flux estimated by the magnetic flux estimation unit.

10: The motor control device according to claim 1, further comprising
a direct torque control execution unit configured to perform direct torque control of the motor using a motor angle and a motor speed computed from the magnetic flux estimated by the magnetic flux estimation unit.
